(19) United States
(12) Patent Application Publication
(10) Pub. No.: US 2010/0263471 A1
(43) Pub. Date: Oct. 21, 2010

(54) Robot having delta kinematics

(75) Inventor: Guenther Weber, Gross Nemerow (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Weber Maschinenbau GmbH Breidenbach, Breidenbach (DE)

(21) Appl. No.: 12/798,568

(22) Filed: Apr. 7, 2010

(30) Foreign Application Priority Data
Apr. 17, 2009 (DE) 10 2009 017 907.0

(51) Int. Cl. B25J 18/06

(52) U.S. Cl. 74/490.06

(57) ABSTRACT

The invention relates to a robot having delta kinematics, comprising a tool receiver which has a joint plate connected to a robot base via control arms and a drive for the rotation of a tool received by the tool receiver, said drive being fastened to the joint plate.

The invention relates to a robot having delta kinematics.

A robot working in accordance with the delta principle, which is also called a delta robot or a parallel robot, is generally known and is used, for example in the area of the food industry, for the fast and accurate positioning of light objects such as food portions by means of vacuum suckers or grippers. A particular advantage of delta kinematics lies in the high dynamics and in the particular accuracy with which positions can be approached.

A delta robot typically includes a robot base, which is usually arranged stationary, and a tool receiver which is movable relative to the robot base and to which a tool, e.g. a gripper, adapted to the respective application area is attached. The tool receiver is connected to the robot base by means of at least three motor-driven, movable control arms. Each control arm includes an upper arm section fastened to the robot base and a lower arm sections pivotally connected to the upper arm section and leading to the tool receiver.

A rotary drive whose torque has to be transferred to the movable tool receiver is typically arranged in a stationary manner in the region of the robot base for the rotation of a tool attached to the tool receiver about its axis which is also called a fourth axis.

Known delta robots have a telescopic axle for this purpose. The torque transfer in this respect takes place by means of a spline shaft or by a laterally offset arrangement of section elements. Both solutions are characterized in that the torque introduction into the telescopic axle takes place via an end of a first part of a sliding seat fixedly connected to the robot base and pivotally journalled, whereas the conducting out of the torque takes place via a second part of the sliding seat which is displaceable relative to the first part and which is attached to the tool receiver.

These devices for the transfer of torque are prone to wear and only suitable for the transfer of smaller torques. A reduction of the necessarily present clearance in the torque transfer device furthermore necessarily results in stiffness of the total system. A further disadvantage is the stroke limitation.

It is the underlying object of the invention to provide a delta robot in which the fourth axle can be driven with a smaller mechanical effort.

A robot having the features of claim 1 is provided to satisfy the object.

The robot in accordance with the invention includes a tool receiver which has a joint plate connected via control arms to a robot base and a drive for the rotation of a tool received by the tool receiver which is fastened to the joint plate.

It is the underlying general idea of the invention not to attach the drive for the rotation of the tool, i.e. the drive for the fourth axle, to the robot base, but rather instead to the joint plate. The drive for the rotation of the tool is therefore in other words integrated into the tool receiver.

No torque therefore has to be transferred in accordance with the invention from the robot base to the tool receiver. The robot in accordance with the invention consequently manages without a device for the transfer of torque between the robot base and the tool receiver and thereby has a simpler mechanical structure. The problems are in particular overcome which result, for example, from the proneness of wear of known torque transfer devices or from the stiffness of the total system due to such torque transfer devices.

Advantageous embodiments of the invention can be seen from the dependent claims, from the description and from the drawing.

In accordance with an embodiment, the drive is formed by a motor, in particular an electric motor. If the motor is moreover a geared motor, a special compact design of the drive is achieved since a transmission is already integrated into the motor in this case and consequently no additional transmission has to be provided between the motor and the tool. The tool can rather be directly coupled to an output shaft of the motor.

The drive is advantageously accommodated in a housing. The robot can hereby be cleaned easily and it thus especially well-suited for hygiene-sensitive applications such as the handling of food products.

In accordance with a further embodiment, the drive is fastened to a side of the joint plate remote from the tool. In other words, the drive is seated on the upper side of the joint plate, whereas the tool is received by the tool receiver at the lower side of the joint plate.

To enable the transfer of torque from the drive seated on the upper side of the joint plate to the tool received at the lower side of the joint plate, a bore is preferably provided in the joint plate. The bore is advantageously centrally orientated, i.e. the center of the bore coincides with the center of the joint plate.

An output shaft of the drive can extend through the bore.

It is furthermore particularly advantageous if a section of the drive engages into the bore, in particular in form-fitted manner, since a correct alignment of the drive relative to the joint plate is hereby ensured in a particularly simple manner.

An output shaft of the drive preferably projects beyond the joint plate so that the tool can be directly coupled to the drive.

A coupling of the tool to be received to the drive is made even more simple if an adapter for the tool to be received is attached to an output shaft of the drive. In this respect, the adapter can be designed such that the tool only has to be placed onto the adapter and is locked thereon by means of a suitable latching arrangement. Such a latching arrangement can, for example, be a latch mechanism and/or a securing screw or a securing pin. So that the adapter does not rotate relative to the tool on a transfer of torque from the drive to the tool, the adapter can have an out-of-round section, for example a multi-sided section which is advantageously adapted to the cross-section of a receiver of the tool for the reception of the adapter.

The invention will be described in the following purely by way of example with reference to an advantageous embodiment and to the enclosed drawing. There are shown:

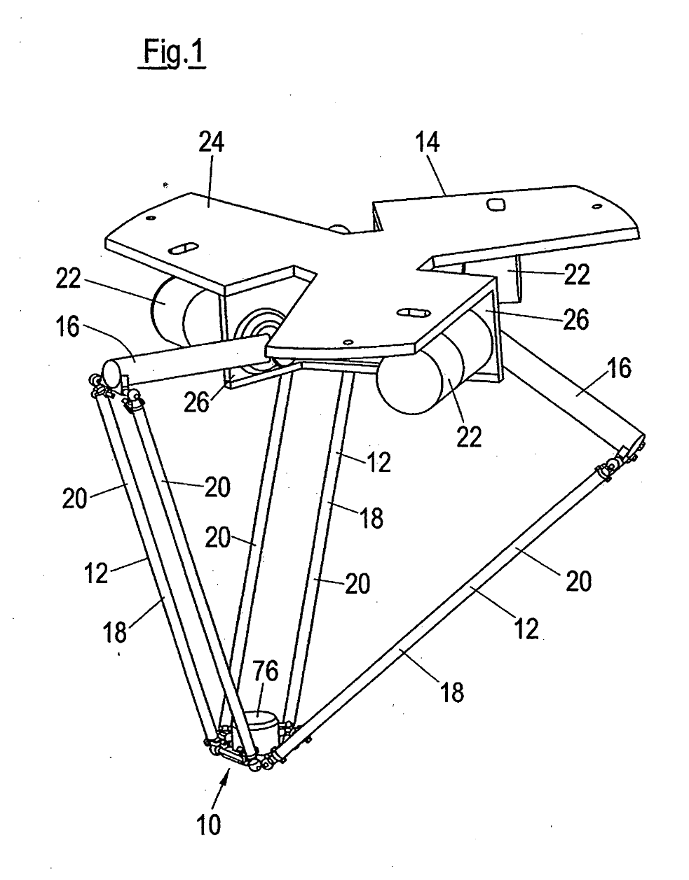

FIG. 1 a perspective view of a robot in accordance with the invention;

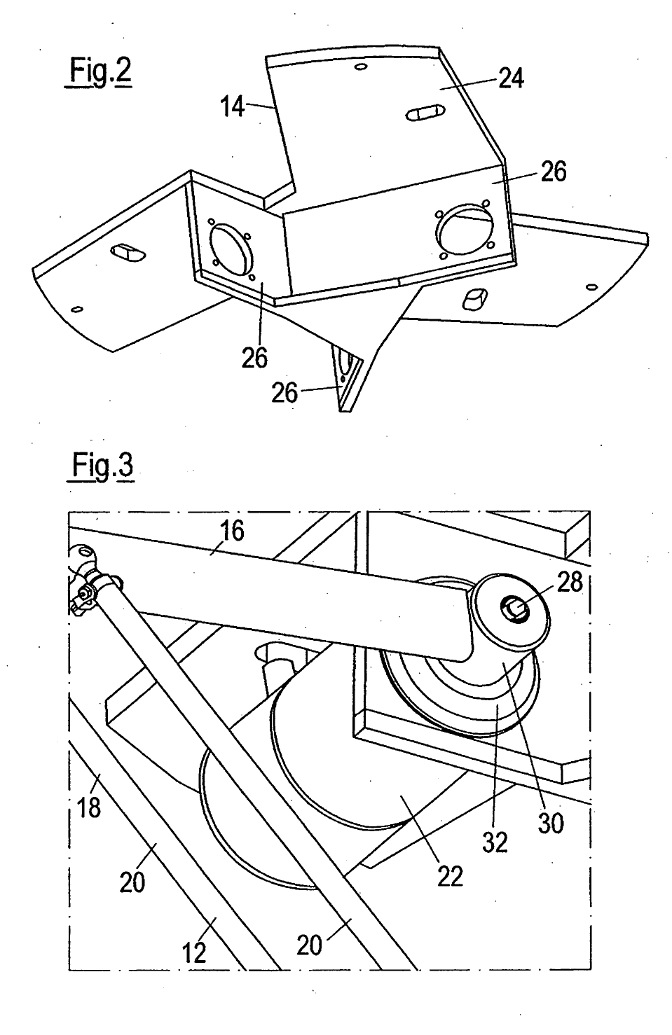

FIG. 2 a perspective view of a robot base of the robot of FIG. 1;

FIG. 3 a perspective part view which shows the fastening of a drive for a control arm of the robot of FIG. 1 to the robot base;

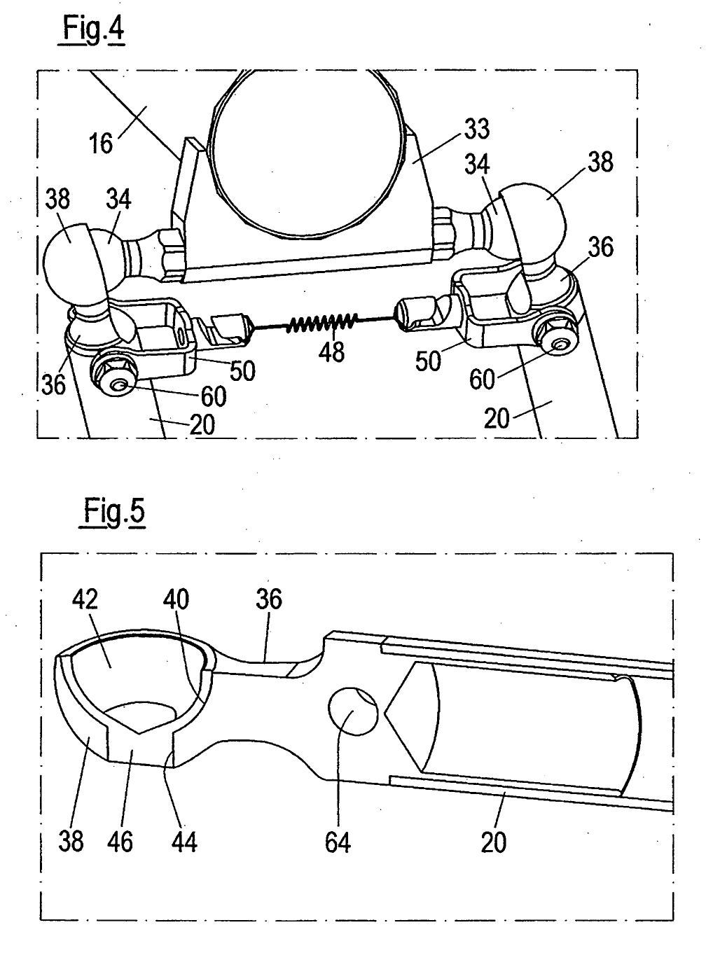

FIG. 4 a perspective part view which shows the bearing of a lower arm section at an upper arm section of a control arm of the robot of FIG. 1;

FIG. 5 a perspective sectional view of a socket member;

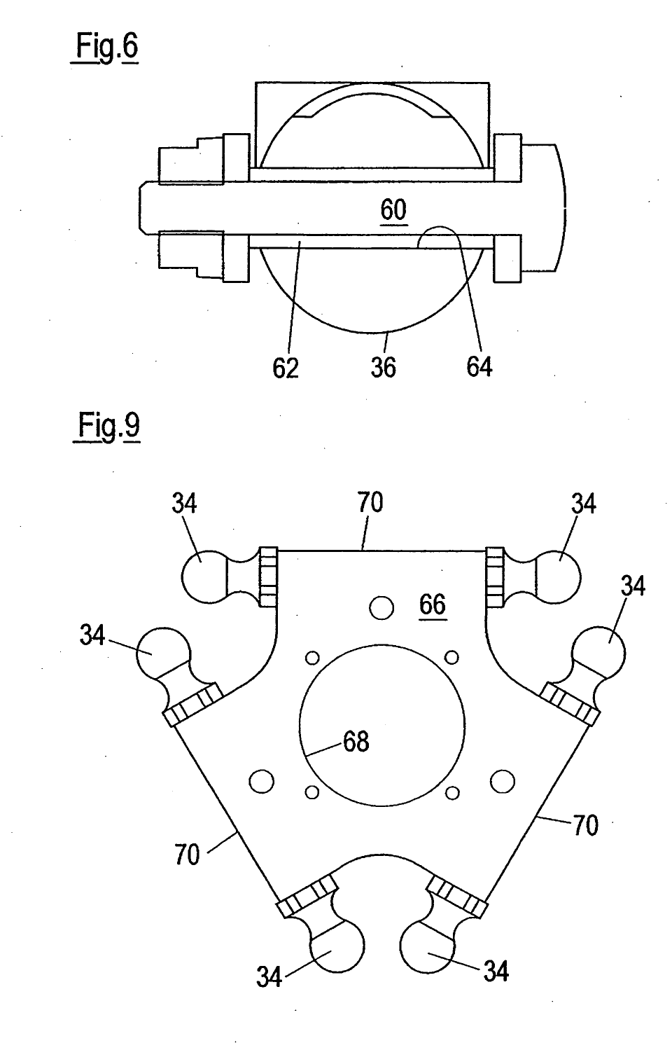

FIG. 6 a cross-sectional view of a socket member with bearing sleeve and fitting screw;

FIG. 7 a perspective view of a tool receiver of the robot of FIG. 1 from above;

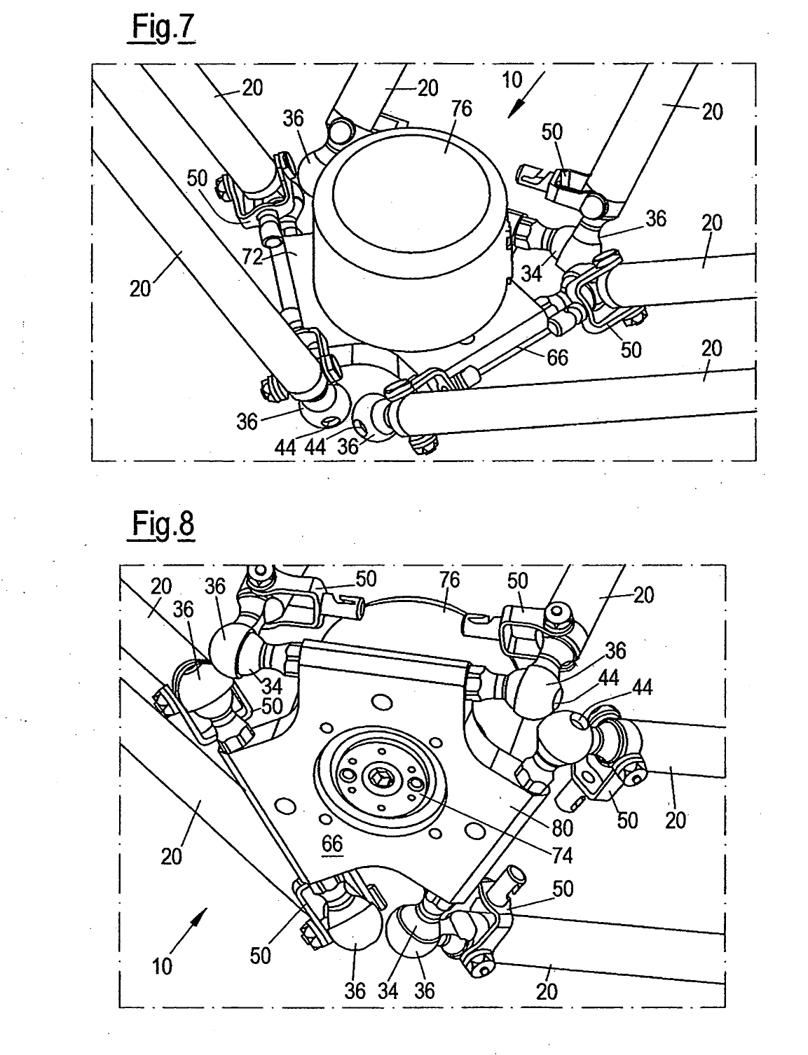

FIG. 8 a perspective view of the tool receiver of FIG. 7 from below;

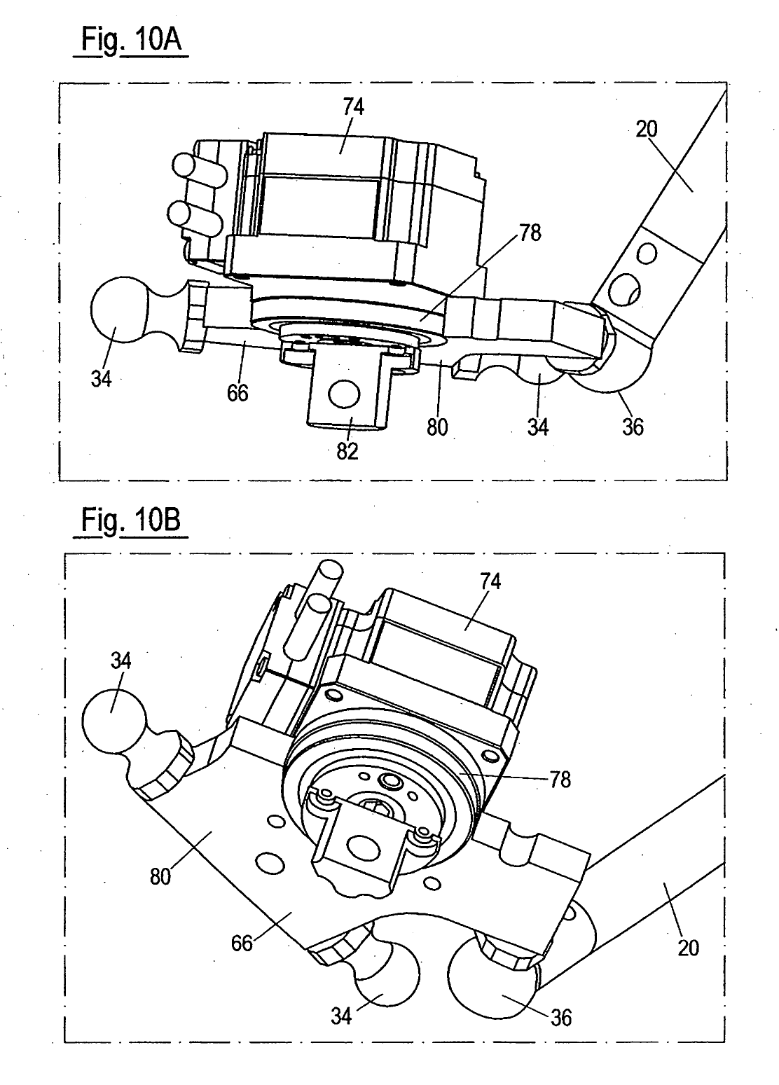

FIG. 9 a plan view of a joint plate with spherical joint heads; and

FIGS. 10A and B perspective views of the tool receiver with cut-way joint plate and non-housed motor.

A delta robot in accordance with the invention is shown in FIG. 1. The robot includes a tool receiver 10 which is connected to a robot base 14 via three control arms 12.

Each control arm 12 includes an upper arm section 16 and a lower arm section 18 which includes a pair of thin-walled tubes 20. The tubes 20 can be made of stainless steel or carbon fiber and are each pivotally connected to the associated upper arm section 16 and to the tool receiver 10.

The upper arm sections 16 are pivotally supported at the robot base 14 offset by 120° to one another. A main drive 22 which includes an electric motor, including transmission and bearing, is associated with each upper arm section 16 to pivot the upper arm sections 16. In this respect, the main drives 22 are designed so that they can be installed without an additional housing. The three main drives 22 are arranged along a circle and are each spaced apart from one another by 120°. In this respect, the axes of rotation of the main drives 22 are parallel to the respective tangents of the circle at an angle offset of 120°.

The robot base 14 has a base plate 24 to whose lower side three plate-shaped bearing seats 26 for the main drives 22 are attached, e.g. welded (FIGS. 1 and 2). The main drives 22 can be screwed to the bearing seats 26.

The robot can be installed, e.g. screwed, to a suitable carrier structure, also called a cell structure, with the help of the robot base 14 and in particular by means of the base plate 24.

Each upper arm section 16 is directly connected, e.g. screwed, to an output shaft 28 of the associated main drive 22. The corresponding screws are covered by a cover 30 (FIG. 3). A seal (not shown) which is implemented in a cover plate 32 is provided between each upper arm section 16 and its associated bearing seat 26.

The pivotal connection of the tubes 20 of a lower arm section 18 to its upper arm section 16 takes place with the help of two ball joints which are arranged on oppositely disposed sides of the upper arm section 16 (FIG. 4).

Each ball joint or spherical bearing includes a joint head or ball member 34 screwed into a carrier part 33 of the upper arm section 16 and a socket member 36 which is associated with the joint head 34 and which is attached to a tube 20 of the lower arm section 16. The socket members 36 can, for example, be adhesively bonded into the tubes 20 and/or can be inserted into them in form-fitted manner.

Each socket member 36 has in a front section 38 remote from the tube 20 a substantially semi-spherically formed bearing socket 40 into which a bearing shell 42 is inserted. The bearing shell 42 is fixed in the bearing socket 40 with friction locking by an interference fit and/or is releasably adhesively bonded thereto. A bore 44 is furthermore provided in the front section 38 of the socket member 36 which makes it possible to press the bearing shell 42 out of the bearing socket 40. To ensure an exact positioning of the bearing shell 42 in the bearing socket 40, the bearing shell 42 has a base 46 which engages in form-fitting manner into the bore 44.

The bearing shells 42 serve for the reception of the joint heads 34 and are accordingly adapted to the shape of the joint heads 34. To prevent a jumping of the socket members 36 off their respective joint head 34, the tubes 20 of a control arm 12 are held together by means of a tension spring 48. The tension spring 48 is connected at each of its ends to a holder 50 in the form of a substantially U-shaped hoop which is pivotably supported at one of the socket members 36 by means of a fitting screw 60. The fitting screw 60 extends through a bearing sleeve 62 which is inserted into a bore 64 extending transversely through the socket member 36 (FIGS. 5 and 6).

Although a tension spring 48 is particularly well suited for the holding together of the tubes 20, it must be pointed out that, instead of the tension spring 48, generally another component with elastic properties, e.g. an elastomer, or a non-resilient connection element can be used to hold the tubes 20 together.

As can be seen from FIG. 1, and in particular also from FIGS. 7 and 8, the pairs of tubes 20 forming the lower arm sections 18 are not only pivotally connected to their respective upper arm section 16, but are rather also pivotally connected to the tool receiver 10, and indeed with the aid of ball joints of the kind such as were described above in connection with FIGS. 4 to 6.

The tool receiver 10 has a joint plate 66 which includes three plate sections 70 which are arranged around a central bore 68 and which are each spaced apart from one another by 120°. Each plate section 70 is associated with a control arm 12. Joint heads 34 are attached to oppositely disposed sides of each plate section 70 and are provided for the reception of the socket members 36 which are connected to the tubes 20 of the corresponding control arm 12. Reference is made to FIGS. 4 to 6 and to the associated description with respect to the structure of these socket members 36. The tubes 20 of a control arm 12 are also held together in the region of the joint plate 66 by a tension spring (not shown) which is connected to the socket members 36 with the aid of holders 50 of the already described kind. A non-elastic connection element can also be used here instead of a tension spring in accordance with the preceding embodiments.

An electric geared motor 74 is arranged at an upper side 72 of the joint plate 66 facing the robot base 14 to rotate a tool, e.g. a gripper, received by the tool receiver 10 about an axis perpendicular to the joint plate 66. The geared motor 74 in other words forms a drive for the so-called fourth axle. The geared motor 74 is accommodated in a housing 76 seated on the joint plate 66 (FIGS. 7 and 8). The geared motor 74 and the housing 76 can be screwed to the joint plate 66.

At its lower side, the geared motor 74 has a base section 78 which engages into the bore 68 of the joint plate 66 in an at least approximately form-fitted manner to ensure a correct positioning of the geared motor 74 on the joint plate 66 (FIGS. 10A and 10B).

An adapter for the tool to be received is attached to a section of an output shaft (not shown) of the geared motor 74 projecting over the lower side 80 of the joint plate 66. The adapter 82 has an out-of-round section, in particular a multi-side section, in a plane perpendicular to the output shaft of the geared motor 74, said section being adapted to the cross-section of a receiver of the tool to be received for the adapter 82 to prevent a rotation of the adapter 82 relative to the received tool. The tool to be received can be flanged directly and in particular without the interposition of an additional transmission to the geared motor 74 via the adapter 82. A support of the fourth axle in the joint plate 66 can be dispensed with by the direct flanging of the tool to the geared motor 74.

### REFERENCE NUMERAL LIST

10 tool receiver
12 control arm
14 robot base
16 upper arm section
18 lower arm section
20 tube
22 main drive
24 base plate
26 bearing seat
28 main drive output
30 cover
32 cover plate
33 carrier part
34 joint head
36 socket member
38 front section
40 bearing socket
42 bearing shell
44 bore
46 base
48 tension spring
50 holder
60 fitting screw
62 bearing sleeve
64 bore
66 joint plate
68 bore
70 plate section
72 upper side
74 geared motor
76 housing
78 base section
80 lower side
82 adapter

1. A robot having delta kinematics, comprising a tool receiver (10) which has a joint plate (66) connected to a robot base (14) via control arms (12) and a drive (74) for the rotation of a tool received by the tool receiver (10), said drive being fastened to the joint plate (66).

2. A robot in accordance with claim 1, characterized in that the drive includes a motor, in particular a geared motor (74).

3. A robot in accordance with claim 1, characterized in that the drive (74) is accommodated in a housing (76).

4. A robot in accordance with claim 1, characterized in that the drive (74) is fastened to a side (72) of the joint plate (66) remote from the tool.

5. A robot in accordance with claim 1, characterized in that a bore (68), in particular a central bore, is provided in the joint plate (66).

6. A robot in accordance with claim 5, characterized in that an output shaft of the drive (74) extends through the bore (68).

7. A robot in accordance with claim 5, characterized in that a section (78) of the drive (74) engages, in particular in form-fitted manner, into the bore (68).

8. A robot in accordance with claim 1, characterized in that a free end section of an output shaft of the drive (74) projects beyond the joint plate (66).

9. A robot in accordance with claim 1, characterized in that an adapter (82) for the tool to be received is attached to an output shaft of the drive (74).
